(19) United States
(12) Patent Application Publication
(10) Pub. No.: US 2005/0182751 A1
(43) Pub. Date: Aug. 18, 2005

(54) Active user support system, support center system, active user support program, and active user support method

(75) Inventors: Hiroshi Kitamura, Tokyo (JP); Masataka Nagura, Tokyo (JP)

Correspondence Address: Paul J. Esatto, Jr.;Scully, Scott, Murphy & Presser, 400 Garden City Plaza, Garden City, NY, 11530, US

(73) Assignee: NEC Corporation, Tokyo (JP)

(21) Appl. No.: 11/057,985

(22) Filed: Feb. 15, 2005

(30) Foreign Application Priority Data
Feb. 16, 2004 (JP) 038686/2004

(51) Int. Cl. G06F 7/00

(52) U.S. Cl. 707/1

(57) ABSTRACT

An active user support system includes a communication apparatus, shop system, support center system, and communication line. In the support center system, an address registration reception apparatus acquires the identification information of the communication apparatus when it is newly connected to the communication line. An address information storage apparatus stores the identification information. A customer/purchase information reception apparatus receives the customer information and purchase information transmitted from the shop system. A customer/purchase information storage apparatus stores the received customer information and purchase information. An extraction apparatus specifies, as a device to be supported, a communication apparatus for which a predetermined period has elapsed from the purchase date/time and whose identification information is not stored and extracts information about the specified communication apparatus from the customer/purchase information storage apparatus.

### BACKGROUND OF THE INVENTION

The present invention relates to a user support system which supports a user in accordance with the use situation of an apparatus having a communication function and, more particularly, to an active user support system, support center system, and active user support method in a large-scale network in which no user registration is necessary, and an appropriate support can actively be provided from the maker side even when a user makes no inquiries.

Conventionally, when a user who has purchased a certain device wants to receive an after-sales service from the maker or shop, he/she must register himself/herself as a user by mailing a registration card or other means (user registration). When the registered user is going to do settings for the purchased device and wants to know the setting method or setting operation, he/she inquires the maker's support center about it by a telephone or the like and receives the support.

According to such procedures, however, a user who has not registered cannot receive the support. For example, assume that a defect in the device is found a short time after release, and inspection or recall of devices is necessary. The maker can neither notify unregistered users nor provide the support.

As a prior art capable of solving this problem, a personal computer user support system is proposed in Japanese Patent Laid-Open No. 2003-263572. According to this system, a user can easily do user registration at the shop when he/she has purchased a personal computer (PC). In addition, when a registered user makes an inquiry, he/she can quickly obtain an appropriate reply from a dedicated user support department.

However, according to this prior art, user registration must be done at the time of purchase. If a user has not registered due to some reason, he/she cannot receive the user support. Additionally, if a user wants to receive a support, he/she must make an inquiry. That is, unless an inquiry is made by the user, the maker cannot provide the user support.

For example, assume that a user has purchased a communication device and interrupted the setting operation because it is too difficult for him/her. In this case, the device remains unused until the setting operation is resumed. However, according to the above-described conventional system, the support is started in response to an inquiry from a user. Hence, even in this case, the maker side cannot actively provide the support in accordance with the state of the user unless an inquiry is made by the user.

In addition, even when the exchange period of expendables of the device is over, the maker side cannot grasp the actual device use situation by the user. For this reason, it is difficult for the maker side to appropriately recommend exchange of expendables or purchase of a new product to the user in accordance with the use situation unless an inquiry is made by the user.

### SUMMARY OF THE INVENTION

It is an object of the present invention to provide an active user support system, support center system, and active user support method capable of actually providing a support from the maker side even when a predetermined period has elapsed from the day of purchase, and no inquiry is made by a user of a device which is not connected to a communication line.

In order to achieve the above object, according to the present invention, there is provided an active user support system comprising a communication apparatus which has a communication function, a shop system which stores customer information and purchase information containing a purchase date/time about the communication apparatus which has purchased, a support center system which specifies a device to be supported from communication apparatuses, and a communication line to which the communication apparatus, the shop system, and the support center system are connected, the support center system comprising identification information registration reception means for, when the communication apparatus is newly connected to the communication line, acquiring identification information of the communication apparatus, identification information storage means for storing the identification information acquired by the identification information registration reception means, customer/purchase information reception means for receiving the customer information and purchase information transmitted from the shop system, customer/purchase information storage means for storing the customer information and purchase information received by the customer/purchase information reception means, and extraction means for specifying, from communication apparatuses whose corresponding customer information and purchase information are stored in the customer/purchase information storage means, a communication apparatus for which a predetermined period has elapsed from the purchase date/time indicated by the purchase information and whose identification information is not stored in the identification information storage means as the device to be supported and extracting information about the specified communication apparatus from the customer/purchase information storage means.

### BRIEF DESCRIPTION OF THE DRAWINGS

FIG. 1 is a block diagram showing the arrangement of an active user support system according to the first embodiment of the present invention;

FIG. 2 is a sequence chart showing processing procedures in the active user support system shown in FIG. 1;

FIG. 3 is a block diagram showing the arrangement of an active user support system according to the second embodiment of the present invention;

FIG. 4 is a sequence chart showing processing procedures in the active user support system shown in FIG. 3;

FIG. 5 is a block diagram showing the arrangement of an active user support system according to the third embodiment of the present invention; and

FIG. 6 is a sequence chart showing processing procedures in the active user support system shown in FIG. 5.

### DESCRIPTION OF THE PREFERRED EMBODIMENTS

Preferred embodiments of an active user support system according to the present invention will be described below with reference to the accompanying drawings.

The active user support system according to each embodiment of the present invention is operated by a computer controlled by a program. The program sends a command to each constituent element of the computer to cause it to execute predetermined processing necessary for the operation of a support center system or the like. The predetermined processing indicates, e.g., address information reception processing, purchase information reception processing, extraction processing of a communication apparatus to be supported, and transmission processing of information of a customer to be supported. The processing and operation in the active user support system of the present invention can be implemented by specific means by cooperation of the program and computer.

The program is stored in a recording medium such as a ROM (Read Only Memory) or RAM (Random Access Memory) in advance. The program in the recording medium loaded in the computer is read out and executed by the computer. The program can be loaded into the computer through, e.g., a communication line. The recording medium which stores the program can be formed by an arbitrary computer-readable recording means such as a semiconductor memory, magnetic disk, or optical disk.

[First Embodiment]

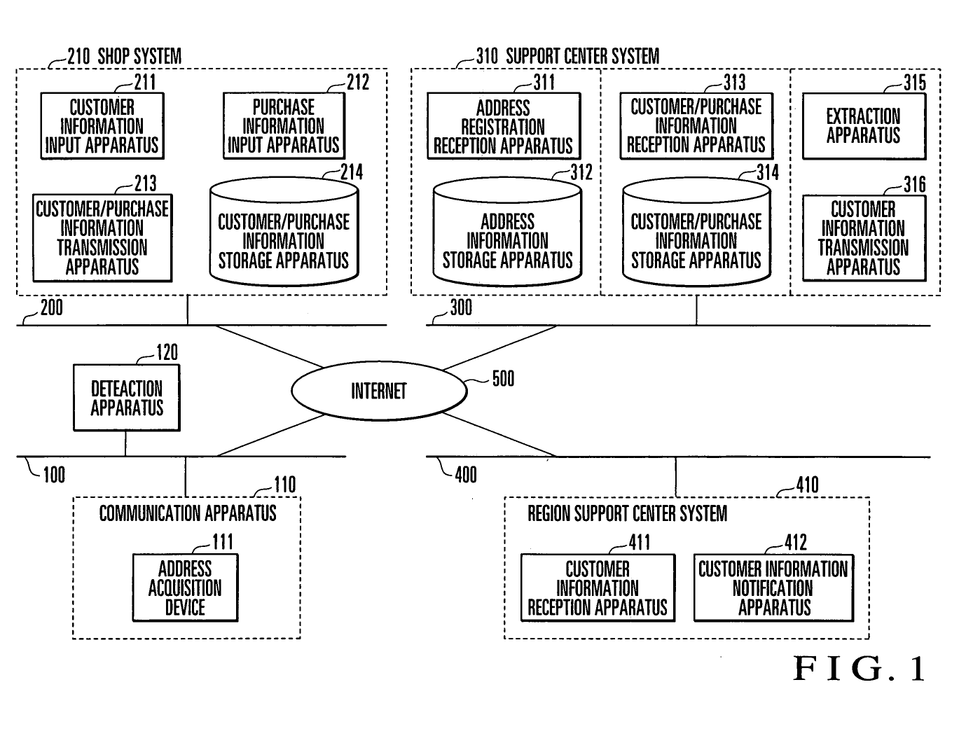

The arrangement of an active user support system according to the first embodiment of the present invention will be described with reference to FIG. 1.

As shown in FIG. 1, the active user support system according to this embodiment comprises a network 100, a communication apparatus 110 added to the network 100, a detection apparatus 120, a shop network 200, a shop system 210, a support center network 300, a support center system 310, a regional network 400, a regional support center system 410, and Internet 500. In this embodiment, instead of making the network 100 itself, which is added to the network 100, register the address in the support center system 310, the detection apparatus 120 is arranged on the network 100 to find the communication apparatus 110 added to the network 100 and register its address.

The communication apparatus 110 added to the network (to be simply referred to as the communication apparatus 110 hereinafter) is an apparatus having a communication function and newly added to the network by a user. The communication apparatus 110 can be, e.g., a personal computer, PDA, PHS, cellular phone, modem, or wireless LAN bridge. The communication apparatus 110 has an address acquisition device 111. When the communication apparatus 110 is newly added to the network 100, the address acquisition device 111 sends a packet for address acquisition setting.

The detection apparatus 120 has a function of detecting the communication apparatus 110 added to the network 100. The detection apparatus 120 detects the packet for address duplication, which is issued in the address settling procedures executed first by the communication apparatus 110 which newly participates in the network 100, and the presence/absence of a response packet to the packet within a predetermined time. Accordingly, participation of the communication apparatus 110 in the network 100 is immediately detected without adding the function to the communication apparatus 110 itself which newly participates in the network 100. The detection apparatus 120 issues a registration request by transmitting address information of the detected communication apparatus 110 to an address registration reception apparatus 311 in the support center system 310.

The shop system 210 includes one or a plurality of information processing apparatuses in the shop where the user purchases the communication apparatus 110. The shop system 210 stores the customer information and purchase information of the user and transmits them to the support center system 310. More specifically, the shop system 210 comprises a customer information input apparatus 211, purchase information input apparatus 212, customer/purchase information transmission apparatus 213, and customer/purchase information storage apparatus 214.

The customer information input apparatus 211 inputs customer information. The customer information can contain, e.g., the customer name, address, telephone number, and e-mail address. The input customer information is stored in the information storage apparatus 214. The purchase information input apparatus 212 inputs the purchase information of the user. The purchase information can contain, e.g., the product name, product identification information, purchase date/time, and purchase amount. The purchase information is stored in the customer/purchase information storage apparatus 214 in association with the customer information.

The customer/purchase information transmission apparatus 213 transmits the customer information and purchase information to the support center system 310. The transmitted purchase information contains at least the product identification information and purchase date/time. The customer/purchase information storage apparatus 214 stores the customer information and purchase information which are input to the shop system 210 by the customer information input apparatus 211 and purchase information input apparatus 212.

The support center system 310 includes one or a plurality of information processing apparatuses used in the support center of the maker. The support center system 310 manages and executes the support to users. The support center system 310 comprises the address registration reception apparatus 311, an address information storage apparatus 312, a customer/purchase information reception apparatus 313, a customer/purchase information storage apparatus 314, an extraction apparatus 315, and a customer information transmission apparatus 316.

The address registration reception apparatus 311 serving as an identification information registration reception means receives an identification information registration request from the detection apparatus 120 and registers the identification information of the communication apparatus 110 in the address information storage apparatus 312. As the identification information, for example, a MAC address can be used. The address information storage apparatus 312 serving as an identification information storage means stores the identification information of each communication apparatus 110.

The customer/purchase information reception apparatus 313 serving as a customer/purchase information reception means stores and registers, in the customer/purchase information storage apparatus 314, the customer information and purchase information received from the shop system 210. The customer/purchase information storage apparatus 314 serving as a customer/purchase information storage means stores the customer information and purchase information.

The extraction apparatus 315 serving as an extraction means extracts the communication apparatus 110 to be supported. The communication apparatus 110 to be supported indicates the communication apparatus 110 which is registered in the customer/purchase information storage apparatus 314 and whose identification information is not registered in the address information storage apparatus 312 for a predetermined time or more. More specifically, the extraction apparatus 315 defines, as a device to be supported, the communication apparatus 110 which satisfies the following three conditions:

a) corresponding customer information and purchase information are stored in the customer/purchase information storage apparatus 314,

b) a predetermined period has elapsed from the purchase date contained in the stored purchase information, and

c) the identification information is not stored in the address information storage apparatus 312. The extraction apparatus 315 extracts, from the customer/purchase information storage apparatus 314, information such as the purchase information about the communication apparatus 110.

The customer information transmission apparatus 316 serving as a customer information transmission means extracts customer information corresponding to the communication apparatus 110 extracted by the extraction apparatus 315. The customer information transmission apparatus 316 specifies the appropriate regional support center system 410 on the basis of the extracted customer information and transmits the customer information to the specified regional support center system 410. The purchase information about the extracted communication apparatus 110 is preferably transmitted to the regional support center system 410 together with the customer information. The transmitted purchase information can contain, e.g., the product name, product identification information, and purchase date/time of the communication apparatus 110.

The regional support center system 410 includes one or a plurality of information processing apparatuses used in a department on the maker side which provides a support to users. The regional support center system 410 sends a support request to an appropriate support worker on the basis of information transmitted from the support center system 310.

The regional support center system 410 comprises a customer information reception apparatus 411 and customer information notification apparatus 412. The customer information reception apparatus 411 serving as a customer information reception means receives customer information transmitted from the support center system 310. The customer information notification apparatus 412 serving as a customer information notification means notifies a support worker (e.g., a staff member of the support center) of the customer information from the support center system 310.

The customer information notification method is not particularly limited. For example, customer information can be displayed on a display device in the regional support center system 410 or printed. Alternatively, customer information can be transmitted by e-mail so that the support worker can refer to it on his/her terminal. If two or more support workers are on standby, each support worker may have a specialized field. In this case, a support worker suitable for the product in the purchase information about the communication apparatus 110 is specified, and various kinds of outputs are done for the support worker.

As shown in FIG. 1, the network 100, shop network 200, support center network 300, and regional network 400 are individual networks to which the communication apparatus 110, shop system 210, support center system 310, and regional support center system 410 are connected, respectively. The networks 100, 200, 300, and 400 are connected to the Internet 500 serving as a large-scale communication line to connect networks to each other so that the networks can communicate with each other.

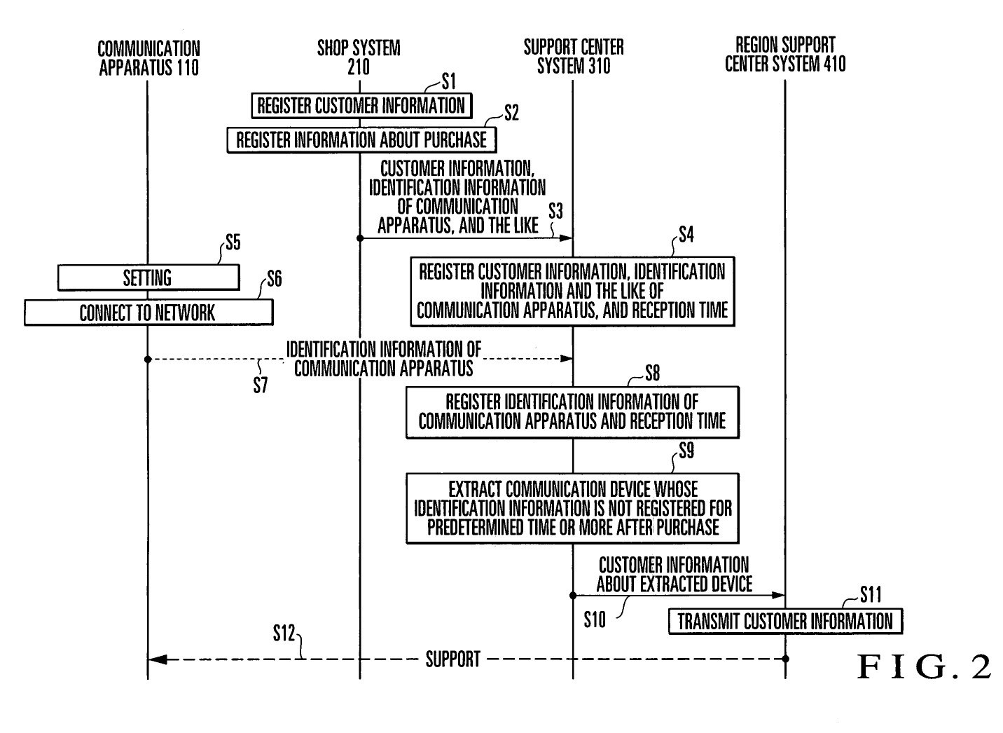

Processing procedures in the active user support system having the above-described arrangement will be described next with reference to FIG. 2.

First, the user purchases the communication apparatus 110 in the shop where the shop system 210 is installed. The user who is a customer of the shop gives customer information to the shop. The customer information is registered in the customer/purchase information storage apparatus 214 in the shop system 210 through the customer information input apparatus 211 (step S1). The purchase information input apparatus 212 also registers information (purchase information) about purchase of the communication apparatus 110 in the customer/purchase information storage apparatus 214 (step S2).

At this time, the customer/purchase information transmission apparatus 213 transmits, to the support center system 310, the customer information and purchase information registered in the customer/purchase information storage apparatus 214 by the customer information input apparatus 211 and purchase information input apparatus 212 (step S3). The purchase information contains at least identification information to specify the communication apparatus 110 purchased by the user and its purchase date/time. As the information to specify the purchased communication apparatus 110, a MAC address to identify the interface included in the communication apparatus 110 can be used.

The customer/purchase information reception apparatus 313 in the support center system 310 registers, in the customer/purchase information storage apparatus 314, the customer information and purchase information containing identification information such as the MAC address of the communication apparatus 110, which are transmitted from the customer/purchase information transmission apparatus 213 in the shop system 210, and the time of reception of these pieces of information (step S4).

On the other hand, the user who has purchased the communication apparatus 110 executes necessary setting (step S5) to connect the communication apparatus 110 to the network 100 (step S6). At this time, connection of the communication apparatus 110 to the network 100 can be detected by the detection apparatus 120. More specifically, the detection apparatus 120 detects connection of the communication apparatus 110 to the network 100 by detecting a packet to set an IP address, which is broadcast from the communication apparatus 110, as described above. The detected packet contains the MAC address to identify the communication apparatus 110. The detection apparatus 120 issues a registration request by transmitting the MAC address to the address registration reception apparatus 311 in the support center system 310.

It is also preferable to cause the communication apparatus 110 itself to notify the support center system 310 of the connection to the network 100 without using the detection apparatus 120. In this case, the communication apparatus 110 itself transmits its MAC address to the address registration reception apparatus 311 in the support center system 310 after connection to the network 100.

In this way, the identification information of the communication apparatus 110 is transmitted from the detection apparatus 120 (or communication apparatus 110) to the support center system 310 so that the support center system 310 is requested to register the address of the communication apparatus 110 (step S7). In step S7, the identification information of the communication apparatus 110 may be transmitted to the support center system 310 not directly from the communication apparatus 110 but through the detection apparatus 120. Taking this into consideration, identification information transmission is indicated by a dotted arrow.

Upon receiving the registration request from the detection apparatus 120 (or communication apparatus 110), the address registration reception apparatus 311 registers the identification information and its reception time in the address information storage apparatus 312 (step S8). The user who has purchased the communication apparatus 110 may be unable to do setting and connect the communication apparatus 110 to the network 100. In this case, the identification information of the communication apparatus 110 is not registered in the address information storage apparatus 312 in step S8.

For this reason, if the identification information of the communication apparatuses 110 is registered in the customer/purchase information storage apparatus 314 but not in the address information storage apparatus 312 yet, it is recognized that the user can neither do setting nor connect the communication apparatus 110 to the network 100 yet. That is, when identification information is registered in the customer/purchase information storage apparatus 314, and the same identification information is not registered in the address information storage apparatus 312 for a predetermined time or more, it is determined that the user cannot do setting of the communication apparatus 110 and needs a support.

The extraction apparatus 315 executes processing for specifying the communication apparatus 110 of the user who probably needs the support. The extraction apparatus 315 periodically checks the customer/purchase information storage apparatus 314 and address information storage apparatus 312, thereby extracting the communication apparatus 110 which is not connected to the network 100 within a predetermined time as a device to be supported (step S9).

More specifically, the extraction apparatus 315 extracts, from the communication apparatuses 110 which are registered in the customer/purchase information storage apparatus 314 but not in the address information storage apparatus 312, the communication apparatus 110 for which the difference between the current date/time and the purchase date/time in the customer/purchase information storage apparatus 314 exceeds a predetermined time. Next, the extraction apparatus 315 extracts information such as the purchase information of the extracted communication apparatus 110 from the customer/purchase information storage apparatus .314. The extraction processing of the communication apparatus 110 to be supported, which is executed by the extraction apparatus 315, can be executed periodically or as needed.

The customer information transmission apparatus 316 in the support center system 310 specifies the regional support center system 410 of the regional support center nearest to the address of the customer on the basis of the customer information corresponding to the communication apparatus 110 extracted by the extraction apparatus 315. The customer information transmission apparatus 316 transmits the customer information corresponding to the extracted communication apparatus 110 to the specified regional support center system 410 (step S10).

When acquisition of customer information corresponding to the extracted communication apparatus 110 is also done in step S9 in addition to extraction of the communication apparatus 110 by the extraction apparatus 315, processing in step S10, i.e., processing for extracting customer information corresponding to the communication apparatus 110 from the customer/purchase information storage apparatus 314 is unnecessary.

The regional support center system 410 may be specified on the basis of not only the address of the customer but also another information. For example, detailed type information of the product may be contained in the purchase information, and a table having information of the regional support center system 410 corresponding to the detailed type information of the product may be prepared in the support center system 310. In this case, the appropriate regional support center system 410 can be specified on the basis of the detailed type information of the product.

The customer information reception apparatus 411 in the regional support center system 410 receives the customer information for the support center system 310. The customer information notification apparatus 412 notifies a support worker of the received customer information (step S11). The support worker provides a support to the customer on the basis of the received customer information by calling or visiting the user (step S12). To explicitly indicate that the support is provided by the staff, the support is indicated by a dotted arrow. In the following embodiments as well, an operation executed by the staff is indicated in the same form.

In this embodiment, the support center (not shown) which manages at least one support center system 310 may directly provide a support, as a matter of course. In this case, when an apparatus having the same function as that of the customer information notification apparatus 412 in the regional support center system 410 is prepared in the support center system 310, the support can be implemented like the regional support center system 410.

According to this embodiment, even when the user of the communication apparatus 110 does not explicitly do user registration or inquiry, the support center of the maker can actively provides a support. At this time, the user who should receive the support can automatically be specified. Hence, user support, which is conventionally only passively executed, can actively be provided from the maker side, and a high-quality support service can be provided.

[Second Embodiment]

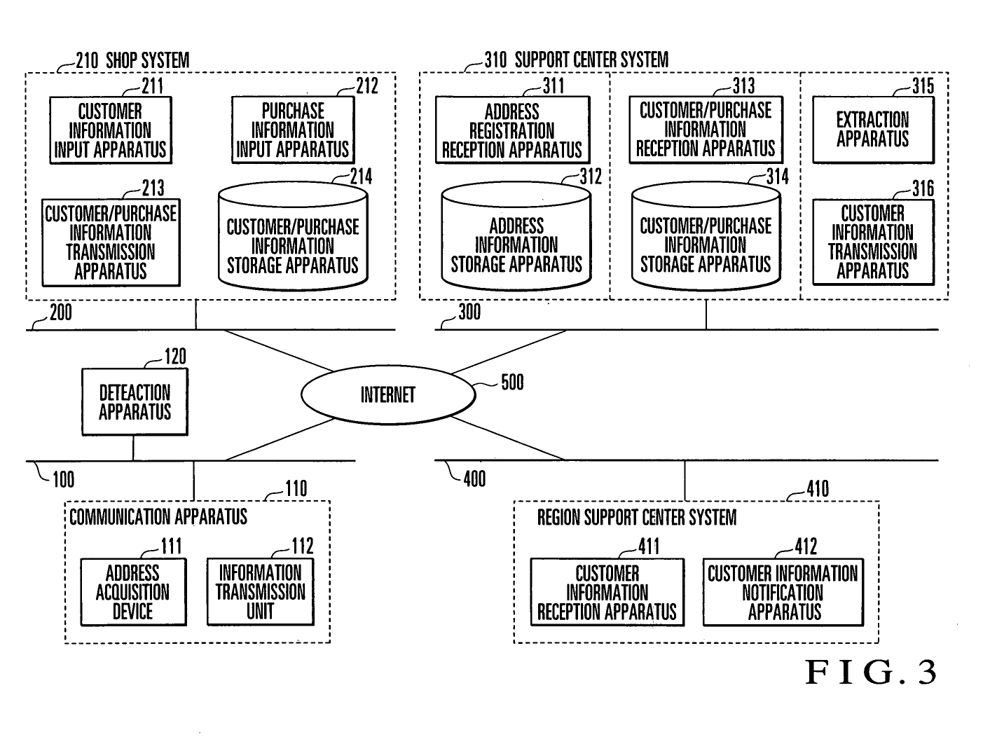

The arrangement of an active user support system according to the second embodiment of the present invention will be described next with reference to FIG. 3.

In this embodiment, information that a user probably needs is actively provided in accordance with use situation of a communication apparatus 110. More specifically, in this embodiment, when the communication apparatus 110 has been used for a long time or continuously after the purchase time, and exchange of expendables is probably necessary, or when it seems to be desirable that the device should be replaced by a new one, the information of the user is automatically extracted and transmitted to the regional support center.

As shown in FIG. 3, the active user support system of this embodiment is different from that of the first embodiment in that the communication apparatus 110 further comprises an information transmission unit 112. When the communication apparatus 110 is connected to a network 100, the information transmission unit 112 periodically transmits the identification information of the communication apparatus 110 to a support center system 310. The identification information transmission can be done not only periodically but also occasionally and, for example, every time the communication apparatus 110 is activated or packets in a predetermined quantity are transmitted.

An address registration reception apparatus 311 in the support center system 310 registers the received identification information of the communication apparatus 110 in an address information storage apparatus 312 together with the reception date/time. Hence, the period or frequency of use of the communication apparatus 110 can be grasped by referring to the log information in the address information storage apparatus 312. An extraction apparatus 315 in the support center system 310 periodically or occasionally refers to the address information storage apparatus 312 and specifies the communication device 110 which seems to have a high use frequency by extracting the identification information.

A customer information transmission apparatus 316 extracts the purchase information of the specified communication apparatus 110 from a customer information storage apparatus 314 and specifies a nearest regional support center system 410 on the basis of the customer information. The customer information transmission apparatus 316 transmits the extracted customer information to the specified regional support center system 410 and requests a support.

Preferably, the extraction apparatus 315 not only extracts the communication apparatus 110 to be supported but also automatically extracts an replacement part or replacement product. For example, a table which stores in advance the correspondence between the use period, the number of times of identification information transmission, and replacement part or product is prepared in the support center system 310. The replacement part or the like can be determined on the basis of the table. The remaining components of the active user support system according to this embodiment are the same as in the first embodiment, and a description thereof will be omitted.

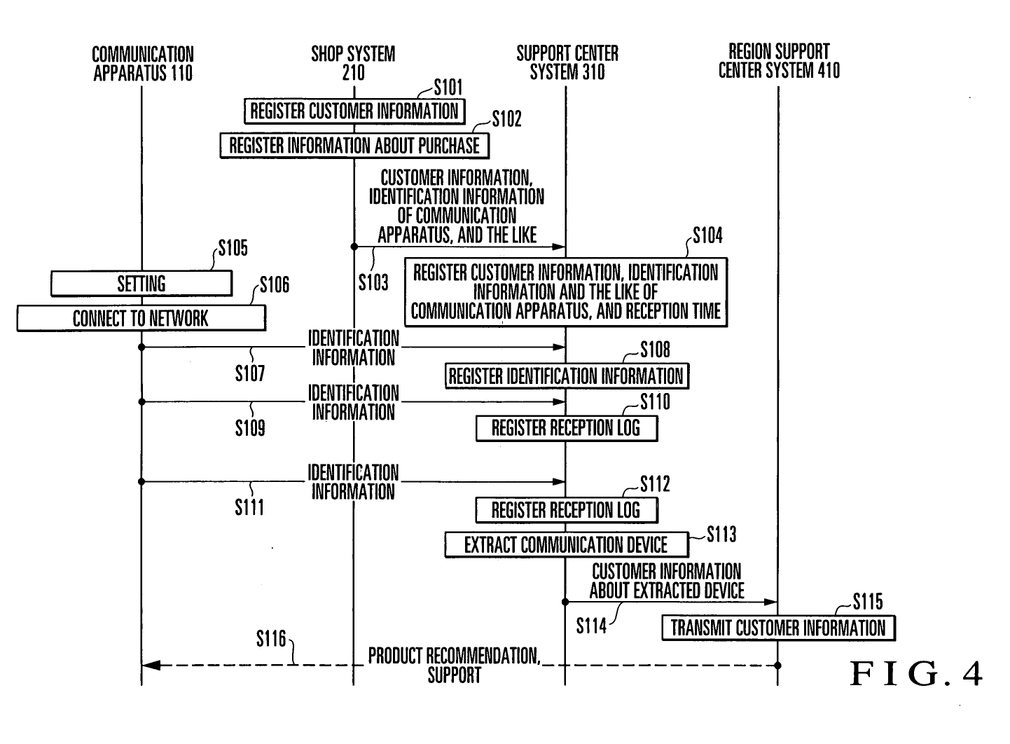

Processing procedures in the active user support system according to this embodiment will be described next with reference to FIG. 4.

Processing from an operation of causing a shop system 210 to register customer information to an operation of causing the support center system 310 to register the identification information of the communication apparatus 110 (steps S101 to S108) is the same as in the operation (steps S1 to S8) of the first embodiment.

After that, the information transmission unit 112 in the communication apparatus 110 periodically or occasionally transmits the identification information of the communication apparatus 110 to the support center system 310, thereby notifying it that connection to the network 100 continues (steps S109 and S111). Upon receiving the identification information from the communication apparatus 110, the address registration reception apparatus 311 in the support center system 310 sequentially registers the identification information in the address information storage apparatus 312 as reception log information (steps S110 and S112).

The extraction apparatus 315 refers to the purchase information of the communication apparatus 110, which is registered in the customer/purchase information storage apparatus 314, and the log information registered in the address information storage apparatus 312 at a predetermined timing, as described above. As a result of reference, the extraction apparatus 315 extracts the communication apparatus 110 with a high use frequency, i.e., an apparatus which has been used for a long time or continuously after the purchase time and the identification information of the apparatus on the basis of the date/time information (step S113).

The customer information transmission apparatus 316 specifies the regional support center system 410 nearest to the address of the customer on the basis of the customer information (customer information or customer information and purchase information) corresponding to the extracted communication apparatus 110 and transmits the customer information to the specified regional support center system 410 (step S114).

In the regional support center system 410, a customer information reception apparatus 411 receives the customer information from the support center system 310. A customer information notification apparatus 412 notifies a support worker of the customer information to request a support (step S115). By using the received customer information, the support worker can execute sales activity or support to provide information of necessary expendables or a new product and recommend purchase of it to the user by calling or visiting him/her (step S116).

According to this embodiment, information of expendables or a new product, which seems to be necessary for the user, can actively be provided from the support center side in accordance with the use situation of the user of the communication apparatus 110.

[Third Embodiment]

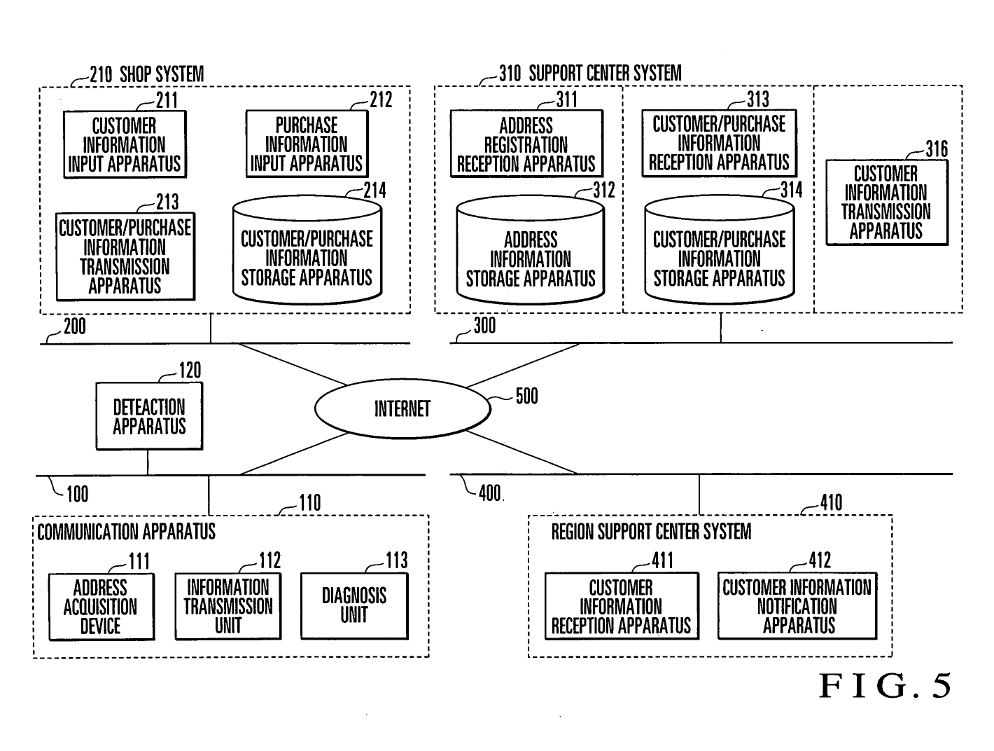

An active user support system according to the third embodiment of the present invention will be described next with reference to FIG. 5.

In this embodiment, a communication apparatus 110 having a self-diagnosis function detects a malfunction or error in a component or consumption of expendables and notifies the support center of the malfunction, error, or consumption situation so that support or product recommendation corresponding to the situation can actively be done from the support center side to the user.

As shown in FIG. 5, the active user support system of this embodiment is different from that of the second embodiment in that the communication apparatus 110 further comprises a diagnosis unit 113, and the extraction apparatus 315 in a support center system 310 is omitted. The diagnosis unit 113 periodically or occasionally executes self-diagnosis for the internal constituent elements in the communication apparatus 110. An information transmission unit 112 transmits the self-diagnosis result to the support center system 310. The targets of self-diagnosis preferably include not only the situation of hardware or software in the communication apparatus 110 but also various kinds of peripheral devices connected to the communication apparatus 110, such as a mouse, loudspeaker, printer, and scanner.

The remaining components of the active user support system according to this embodiment are the same as in the second embodiment, and a description thereof will be omitted.

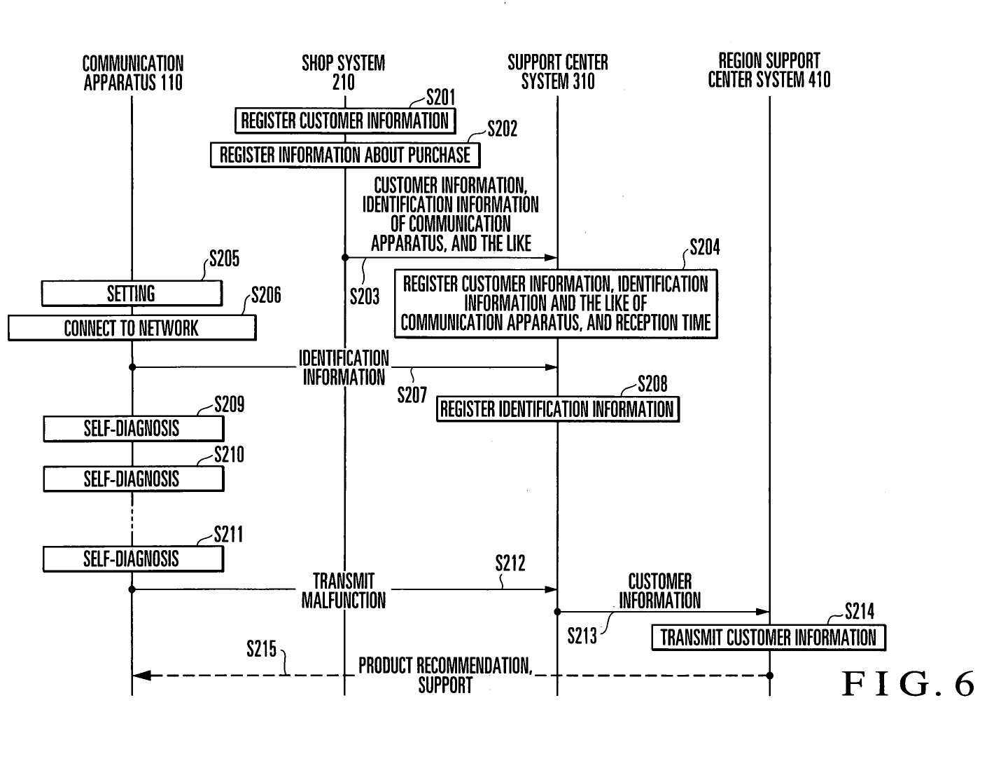

Processing procedures in the active user support system according to this embodiment will be described next with reference to FIG. 6.

Processing from an operation of causing a shop system 210 to register customer information to an operation of causing the support center system 310 to register the identification information of the communication apparatus 110 (steps S201 to S208) is the same as in the operation (steps S1 to S8) of the first embodiment.

After that, the diagnosis unit 113 in the communication apparatus 110 periodically or occasionally executes predetermined self-diagnosis (steps S209 to S211). If a malfunction or error in an internal constituent element of the communication apparatus 110 or a peripheral device of the communication apparatus 110 or consumption of expendables is detected as a result of diagnosis by the diagnosis unit 113, the information transmission unit 112 notifies the support center system 310 of it by transmitting information representing the contents of problem to the support center system 310 (step S212). This notification contains information to identify the constituent element with the malfunction, error, or consumption or information to transmit the situation of the malfunction, error, or consumption.

When the support center system 310 receives the notification, on the basis of the identification information of the transmission source, a customer information transmission apparatus 316 in the support center system 310 extracts the customer information of the corresponding communication apparatus 110 from a customer/purchase information storage apparatus 314. Next, the customer information transmission apparatus 316 transmits the extracted customer information to the nearest regional support center on the basis of the address in the customer information (step S213).

A customer information reception apparatus 411 in a regional support center system 410 receives the customer information from the support center system 310. A customer information notification apparatus 412 notifies a support worker of the customer information to request a support (step S214). By using the received customer information, the support worker can provide a support such as repair of the defective part or execute sales activity to provide information of necessary expendables or a new product and recommend purchase of it to the user by calling or visiting him/her (step S215).

According to this embodiment, a support to the user can be provided on the basis of a result of self-diagnosis by the communication apparatus 110 itself. Hence, the support that the user needs can more reliably be provided.

The present invention is not limited to the above-described embodiments, and various changes and modifications can be made within the spirit and scope of the present invention. For example, the embodiments can be combined. For example, the first and second embodiments or the first and third embodiments may be combined. In this case, a support is provided to the user of the communication apparatus 110 which is not connected to the network 100 for a predetermined time or more after purchase. Additionally, after connection, a support or product recommendation can be done on the basis of the use situation or self-diagnosis result.

When the second and third embodiments are combined, product recommendation can be done on the basis of the use situation, and additionally, a support based on a self-diagnosis result can actively be provided. In the above-described embodiments, customer information extraction processing is executed by the customer information transmission apparatus 316 in the support center system 310. Instead, this processing may be executed by the extraction apparatus 315.

As has been described above, according to the present invention, the maker side can provide a support to even a user who has not executed user registration. Even without any inquiry from the user, the maker side can actively provide a support if it seems to be necessary.

In addition, the maker side can actively provide information of, e.g., expendables or new product, which seems to be necessary for the user, in accordance with the user's use situation of the communication apparatus.

Furthermore, when a communication apparatus having a self-diagnosis function executes self-diagnosis, detects a malfunction in a part or consumption of expendables, and transmits it to the support center system, the maker side can provide a corresponding support to the user.

1. An active user support system comprising:
a communication apparatus which has a communication function;
a shop system which stores customer information and purchase information containing a purchase date/time about said communication apparatus which has purchased;
a support center system which specifies a device to be supported from communication apparatuses; and
a communication line to which said communication apparatus, said shop system, and said support center system are connected,
said support center system comprising
identification information registration reception means for, when said communication apparatus is newly connected to the communication line, acquiring identification information of said communication apparatus,
identification information storage means for storing the identification information acquired by said identification information registration reception means,
customer/purchase information reception means for receiving the customer information and purchase information transmitted from said shop system,
customer/purchase information storage means for storing the customer information and purchase information received by said customer/purchase information reception means, and
extraction means for specifying, from communication apparatuses whose corresponding customer information and purchase information are stored in said customer/purchase information storage means, a communication apparatus for which a predetermined period has elapsed from the purchase date/time indicated by the purchase information and whose identification information is not stored in said identification information storage means as the device to be supported and extracting information about the specified communication apparatus from said customer/purchase information storage means.

2. A system according to claim 1, further comprising a regional support center system which outputs a support request to a support worker,
said support center system comprising customer information transmission means for extracting customer information and purchase information corresponding to said communication apparatus to be supported from said customer/purchase information storage means and transmitting the customer information to said regional support center system selected on the basis of the extracted information.

3. A system according to claim 2, wherein
said communication apparatus executes self-diagnosis at one of a periodical timing and an occasional timing, and when a problem related to at least one of a malfunction, error, and consumption is detected as a result of self-diagnosis, transmits problem information to said support center system, and
one of said extraction means and said customer information transmission means specifies said communication apparatus which has transmitted the problem information as the device to be supported and extracts customer information corresponding to said specified communication apparatus from said customer/purchase information storage means.

4. A system according to claim 1, wherein
said communication apparatus transmits predetermined information to said support center system at one of a periodical timing and an occasional timing,
said identification information registration reception means accumulates the received predetermined information in said identification information storage means as log information, and
said extraction means specifies, as the device to be supported, at least one of said communication apparatus which has been used for not less than a predetermined period and said communication apparatus having a high use frequency and extracts information about said specified communication apparatus from said identification information storage means at one of a periodical timing and an occasional timing.

5. A support center system which specifies, as a device to be supported, a communication apparatus which has a communication function and is not connected to a communication line within a predetermined period, comprising:
identification information registration reception means for, when the communication apparatus is newly connected to the communication line, acquiring identification information of the communication apparatus;
identification information storage means for storing the identification information acquired by said identification information registration reception means;
customer/purchase information reception means for receiving customer information corresponding to the communication apparatus and purchase information containing a purchase date/time, which are transmitted from a shop system;
customer/purchase information storage means for storing the customer information and purchase information received by said customer/purchase information reception means; and
extraction means for specifying, from communication apparatuses whose corresponding customer information and purchase information are stored in said customer/purchase information storage means, a communication apparatus for which a predetermined period has elapsed from the purchase date/time indicated by the purchase information and whose identification information is not stored in said identification information storage means as the device to be supported and extracting information about the specified communication apparatus from said customer/purchase information storage means.

6. A system according to claim 5, further comprising customer information transmission means for extracting, from said customer/purchase information storage means, at least one of customer information and purchase information corresponding to the communication apparatus to be supported and transmitting the customer information to a regional support center system selected on the basis of the extracted information, which outputs a support request to a support worker.

7. A system according to claim 6, wherein when information about at least one of a malfunction, error, and consumption detected by self-diagnosis by the communication apparatus at one of a periodical timing and an occasional timing is received, one of said extraction means and said customer information transmission means specifies the communication apparatus which has transmitted the problem information as the device to be supported and extracts customer information corresponding to the specified communication apparatus from said customer/purchase information storage means.

8. A system according to claim 5, wherein
said identification information registration reception means accumulates predetermined information received from the communication apparatus at one of a periodical timing and an occasional timing in said identification information storage means as log information, and
said extraction means specifies, as the device to be supported, at least one of the communication apparatus which has been used for not less than a predetermined period and the communication apparatus having a high use frequency and extracts information about the specified communication apparatus from said identification information storage means at one of a periodical timing and an occasional timing.

9. An active user support program which specifies a device to be supported in a support center system including customer/purchase information storage means for storing customer information about a purchased communication apparatus and purchase information containing a purchase date/time, and identification information storage means for storing identification information of the communication apparatus, which is acquired when the communication apparatus is newly connected to a communication line, comprising:
a program to execute specifying, from communication apparatuses whose corresponding customer information and purchase information are stored in the customer/purchase information storage means, a communication apparatus for which a predetermined period has elapsed from the purchase date/time indicated by the purchase information and whose identification information is not stored in the identification information storage means as the device to be supported and extracting information about the specified communication apparatus from the customer/purchase information storage means.

10. An active user support method of specifying, as a device to be supported, a communication apparatus which has a communication function and is not connected to a communication line within a predetermined period, comprising steps of:
causing a shop system to transmit customer information and purchase information containing a purchase date/time about the communication apparatus which has purchased to a support center system through the communication line;
causing the support center system to store the received customer information and purchase information;
causing the support center system to store identification information of the communication apparatus, which is received when the communication apparatus is connected to the communication line;
causing the support center system to specify, from communication apparatuses whose corresponding customer information and purchase information are stored, a communication apparatus for which a predetermined period has elapsed from the purchase date/time indicated by the purchase information and whose identification information is not stored as the device to be supported;
extracting customer information corresponding to the specified communication apparatus and transmitting the customer information to a regional support center system; and
causing the regional support center system to output a support request on the basis of the received customer information.
